(19) United States
(12) Patent Application Publication
(10) Pub. No.: US 2006/0274216 A1
(43) Pub. Date: Dec. 7, 2006

(54) Broadcast receiving set, broadcast receiver device, channel selecting method, and channel selecting program product

(75) Inventor: Takahiro Katayama, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/445,127

(22) Filed: Jun. 1, 2006

(30) Foreign Application Priority Data
Jun. 1, 2005 (JP) 2005-161246

(51) Int. Cl. H04N 5/50

(52) U.S. Cl. 348/731

(57) ABSTRACT

On the condition that a different channel is not selected upon the elapse of a prescribed time after the channel selection, channel information of the desired channel is stored in a history list that can specify the order in which desired channels are selected. According to a historical channel-selection operation by a history button, historical channel-selection is performed to select a channel having channel information stored at an ordinal position that temporally precedes an ordinal position of channel information of a channel selected last time. In addition, upon reception of a historical channel-selection operation after a predetermined time has passed since the historical channel selection, historical channel-selection is performed to select a channel at the last position in terms of time, so that a broadcast on the selected channel is output. Therefore, the burden of selecting a channel is decreased.

### BACKGROUND OF THE INVENTION

1. Field of the Invention

The present invention relates to a broadcast receiving set, a broadcast receiver device, a channel selecting method, and a channel selecting program product. More particularly, the present invention relates to a broadcast receiving set, a broadcast receiver device, a channel selecting method, and a channel selecting program product, which are suitable to select a desired channel.

2. Description of the Background Art

Conventionally, television broadcast channels are selected by operating a channel-selection button of a remote control or a television set.

Japanese Patent Laying-Open No. 2000-101941 (referred to as “Patent Document 1” hereinafter) discloses a program selection control apparatus choosing a plurality of programs that can be provided at the present time and are similar to a program frequently viewed in this time zone, using information of accumulated past channel history and the present time information, and then sequentially switching channels broadcasting the programs as recommended programs in decreasing order of similarity for outputting a recommended program (see, for example, the paragraph 0016 of Patent Document 1”).

Japanese Patent Laying-Open No. 2000-224509 (referred to as “Patent Document 2” hereinafter) discloses an information receiving device creating and displaying a program list having a dedicated channel-selection button for the channel most frequently viewed by the operator (see, for example, the paragraph 0029 of Patent Document 2).

Japanese Patent Laying-Open No. 2000-349672 (referred to as “Patent Document 3” hereinafter) discloses a digital broadcast receiver detecting header information included in the received broadcast wave, identifying all the channels being broadcasted based on the header information, arranging the order in which these channels are selected according to a prescribed rule, upon the user's channel selecting operation, selecting channels in order according to the arranged channel-selecting order, extracting broadcast data of the selected channel based on the header information of the selected channel, and outputting the extracted data to the following stage (see, for example, the paragraph 0012 of Patent Document 3).

Japanese Patent Laying-Open No. 2002-290765 (referred to as “Patent Document 4” hereinafter) discloses an automatic reception method and a television receiver determining a key operator based on a resistance value corresponding to a key pressure applied when a remote control key is operated, and in addition, specifying reception history information for the key operator, and when the registered, reception time zone included in the reception history information has come, automatically receiving a reception channel registered in the reception time zone (see, for example, the paragraph 0042 of Patent Document 4).

Japanese Patent Laying-Open No. 10-304267 (referred to as “Patent Document 5” hereinafter) discloses a digital broadcast receiver reading viewing program data from a memory and displaying the same in the form of a viewing history list on a television screen by OSD in decreasing order of broadcasting time or in alphabetical order of program names (see, for example, the paragraph 0039 of Patent Document 5).

However, the number of television broadcast channels has conventionally been increasing in the United States. Recently, also in Japan, the number of channels of television broadcasting as well as the conventional satellite digital broadcasting has further increased partly because Terrestrial Digital Broadcasting has been launched. Therefore, the users have to search many channels for a desired channel, so that channel selection becomes increasingly burdensome.

Furthermore, according to the program selection control apparatus disclosed in Patent Document 1, the information receiving device disclosed in Patent Document 2, the digital broadcast receiver disclosed in Patent Document 3, and the automatic reception method and the television receiver disclosed in Patent Document 4, it is necessary to choose similar programs, choose a frequently-viewed channel, identify header information, or record reception history information for each operator, for each day of the week, for each time, thereby complicating the processes. Therefore, the time required for processing increases with the increasing number of channels, because of the complicated processing. Thus, it becomes impossible to easily select a frequently-viewed channel, so that the users are increasingly burdened with selecting channels.

Furthermore, according to the digital broadcast receiver disclosed in Patent Document 5, it is possible to display a viewing history list. However, channel selection is not facilitated.

### SUMMARY OF THE INVENTION

The present invention is made to solve the aforementioned problems. An object of the present invention is to provide a broadcast receiving set allowing reduction of the burden of the user selecting a channel, a broadcast receiver device, a channel selecting method, and a channel selecting program product.

In order to solve the aforementioned problems, in accordance with an aspect of the present invention, a broadcast receiver device includes a channel-selection operation reception unit, a channel-selection control unit, an order storing unit, a particular channel-selection operation reception unit, and a particular channel-selection control unit.

The channel-selection operation reception unit receives a channel-selection operation to select a desired channel from a plurality of channels. The channel-selection control unit performs channel-selection control to select the desired channel according to the channel-selection operation received by the channel-selection operation reception unit. The order storing unit stores the desired channel such that an order in which the channel-selection control for the desired channel is performed by the channel-selection control unit can be specified. The particular channel-selection operation reception unit receives a particular channel-selection operation to select a channel based on the order stored in the order storing unit. The particular channel-selection control unit performs particular channel-selection control according to the particular channel-selection operation received by the particular channel-selection operation reception unit, to select a channel stored in the order storing unit at an ordinal position temporally preceding an ordinal position in which a channel selected last time is stored in the order storing unit.

In accordance with the present invention, the broadcast receiver device receives a channel-selection operation to select a desired channel from a plurality of channels, performs channel-selection control to select the desired channel according to the received channel-selection operation, and stores the desired channel such that the order in which channel-selection control for the desired channel is performed can be specified.

In addition, a particular channel-selection operation is received to select a channel based on the stored order. According to the received particular channel-selection operation, particular channel-selection control is performed to select a channel stored at an ordinal position that temporally precedes an ordinal position in which a channel selected last time is stored.

Therefore, every time a particular channel-selection operation is received, a channel at an ordinal position temporally preceding is selected according to the order in which channels are selected through channel-selection control. As a result, a channel selected in the past can easily be selected, thereby providing a broadcast receiver device allowing reduction of the burden of the user selecting a channel.

Preferably, the order storing unit stores the desired channel as channel specifying information that can specify the desired channel.

Preferably, the order storing unit stores the desired channel on the condition that when the channel-selection control for a different channel is not performed by the channel-selection control unit when a prescribed time has passed since the channel-selection control was performed by the channel-selection control unit.

In accordance with the present invention, the broadcast receiver device can store a desired channel on the condition that channel-selection control for a different channel is not performed when a prescribed time has passed since channel-selection control was performed.

Therefore, a desired channel that is not switched to a different channel for a prescribed time can be stored. As a result, only such an interested channel can be stored that is not switched and left as it is by the user for a prescribed time or longer.

Preferably, the particular channel-selection control unit performs the particular channel-selection control to select a channel at a last position in terms of time, when the particular channel-selection operation was received by the particular channel-selection operation reception unit after a predetermined time has passed since the particular channel-selection control was performed by the particular channel-selection control unit.

In accordance with the present invention, the broadcast receiver device selects a channel stored at the last position in terms of time when a particular channel-selection operation is received after a predetermine time has passed after particular channel-selection control was performed.

Therefore, when the user does not switch and leaves the channel selected by a particular channel-selection operation for a predetermined time or longer, a particular channel-selection operation can newly be performed, starting from the channel stored at the last position in terms of time.

Preferably, the order storing unit stores each of a channel selected through the channel-selection control by the channel-selection control unit and a channel selected through the particular channel-selection control by the particular channel-selection control unit.

In accordance with the present invention, the broadcast receiver device stores each of a channel selected through channel-selection control and the channel selected through particular channel-selection control such that the order stored can be specified.

Therefore, every time a particular channel-selection operation is received, the channels at ordinal positions temporally preceding, including not only the channel selected through channel-selection control but also the channel selected through particular channel-selection control, are stored. As a result, the channels selected in the past, including the channel selected through particular channel-selection operation, can easily be stored, thereby further reducing the burden of the user selecting a channel.

Preferably, when the desired channel selected through the channel-selection control by the channel-selection control unit is an already-stored channel that has already been stored, the order storing unit newly stores the desired channel at a last position in terms of time and also deletes the already-stored channel.

In accordance with the present invention, the broadcast receiver device newly stores a desired channel at the last position and also deletes the already-stored channel when the desired channel selected through channel-selection control is the already-stored channel that has already been stored.

Therefore, even the already-stored channel is newly stored at the last position when channel-selection control is performed, so that desired channels can be stored in the order frequently selected. As a result, the channels selected in the past can be selected in the order frequently selected, thereby further reducing the burden of the user selecting a channel.

Preferably, the channel-selection operation reception unit is a channel-selection button. The order storing unit is a history list storing unit. The particular channel-selection operation reception unit is a history button. The particular channel-selection operation is a historical channel-selection operation. The particular channel-selection control is historical channel-selection control.

Furthermore, the history list storing unit stores channel information that can specify the desired channel in a history list that can specify an order in which the channel-selection control for the desired channel is performed by the channel-selection control unit, on the condition that the channel-selection control for a different channel is not performed by the channel-selection control unit when a prescribed time has passed after the channel-selection control was performed by the channel-selection control unit. In addition, when the desired channel selected through the channel-selection control by the channel-selection control unit is an already-stored channel that has already been stored, the history list storing unit newly stores the channel information that can specify the desired channel at a last position in terms of time in the history list and also deletes the channel information of the already-stored channel from the history list;

In accordance with another aspect of the present invention, a channel selecting method of selecting a channel by a broadcast receiver device includes the steps of: receiving a channel-selection operation to select a desired channel from a plurality of channels; performing channel-selection control to select the desired channel according to the received channel-selection operation; storing the desired channel such that an order in which the channel-selection control for the desired channel is preformed can be specified; receiving a particular channel-selection operation to select a channel based on the stored order; and performing particular channel-selection control according to received the particular channel-selection operation to select a channel stored at an ordinal position temporally preceding an ordinal position in which a channel selected last time is stored.

In the channel selecting method in accordance with the present invention, a channel-selection operation is received to select a desired channel from a plurality of channels. Channel-selection control is performed to select the desired channel according to the received channel-selection operation. The desired channel is stored such that the order in which channel-selection control for the desired channel is performed can be specified.

Furthermore, a particular channel-selection operation is received to select a channel based on the stored order. Particular channel-selection control is performed according to the received particular channel-selection operation to select a channel stored at the ordinal position that temporally precedes the ordinal position in which a channel selected last time is stored.

Therefore, every time a particular channel-selection operation is received, a channel at an ordinal position temporally preceding is selected according to the order in which channels are selected through channel-selection control. As a result, a channel selected in the past can easily be selected, thereby providing a channel selecting method that allows reduction in the burden of the user selecting a channel.

In accordance with a further aspect of the present invention, a channel selecting program product causes a broadcast receiver device to perform the steps of: receiving a channel-selection operation to select a desired channel from a plurality of channels; performing channel-selection control to select the desired channel according to the received channel-selection operation; storing the desired channel such that an order in which the channel-selection control for the desired channel is preformed can be specified; receiving a particular channel-selection operation to select a channel based on the stored order; and performing particular channel-selection control according to received the particular channel-selection operation to select a channel stored at an ordinal position temporally preceding an ordinal position in which a channel selected last time is stored.

In the channel selecting program product in accordance with the present invention, a channel-selection operation is received to select a desired channel from a plurality of channels. Channel-selection control is performed to select the desired channel according to the received channel-selection operation. The desired channel is stored such that the order in which channel-selection control for the desired channel is performed can be specified.

Furthermore, a particular channel-selection operation is received to select a channel based on the stored order. Particular channel-selection control is performed according to the received particular channel-selection operation to select a channel stored at the ordinal position that temporally precedes the ordinal position in which a channel selected last time is stored.

Therefore, every time a particular channel-selection operation is received, a channel at an ordinal position temporally preceding is selected according to the order in which channels are selected through channel-selection control. As a result, a channel selected in the past can easily be selected, thereby providing a channel selecting program product that allows reduction in the burden of the user selecting a channel.

In accordance with yet another aspect of the present invention, a broadcast receiving set includes the broadcast receiver device as described above and an output unit outputting a broadcast on a channel selected by the channel-selection control unit or the particular channel-selection control unit.

In accordance with the present invention, the broadcast receiving set outputs a broadcast on the channel selected by the broadcast receiver device as described above.

Therefore, a channel selected in the past can easily be selected, thereby providing a broadcast receiving set allowing reduction of the burden of the user selecting a channel.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic configuration diagram of a broadcast receiving set according to a first embodiment of the present invention.

FIG. 2 is a schematic view of a remote control of the broadcast receiving set according to the first embodiment of the present invention.

FIG. 3 is a flowchart illustrating a flow of a channel selecting process according to the first embodiment of the present invention.

FIG. 4 is a flowchart illustrating a flow of a history button process that is a subroutine of the channel selecting process according to the first embodiment of the present invention.

FIG. 5 is a flowchart illustrating a flow of a channel selecting process according to a second embodiment of the present invention.

FIG. 6 is a schematic configuration diagram of a broadcast receiver device according to a third embodiment of the present invention.

### DESCRIPTION OF THE PREFERRED EMBODIMENTS

In the following, embodiments of the present invention will be described in detail with reference to the figures. It is noted that in the figures the same or corresponding parts will be denoted with the same reference characters and the detailed description thereof will not be repeated.

### First Embodiment

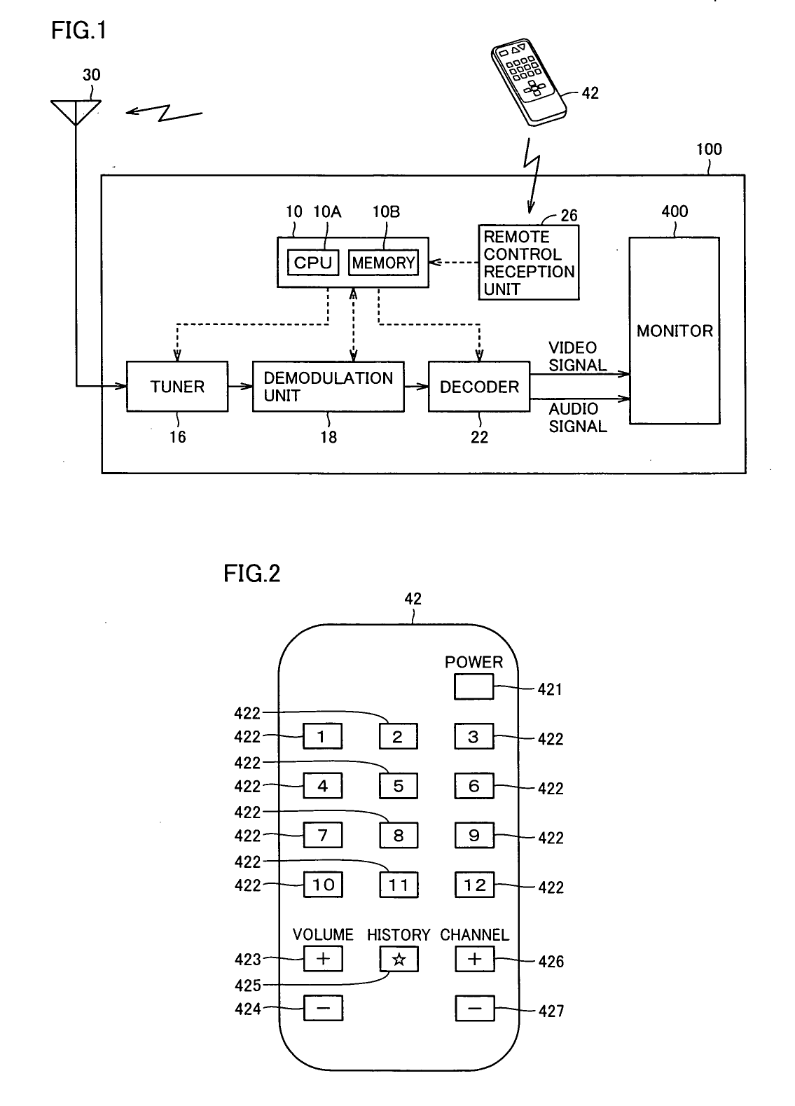

Referring to FIG. 1, a broadcast receiving set 100 in accordance with a first embodiment of the present invention receives a broadcast signal from an antenna 30, receives an instruction signal from a remote control 42, and outputs a video signal and an audio signal from a monitor 400.

Antenna 30 receives a broadcast signal transmitted via radio waves from a broadcast station to supply the received broadcast signal to broadcast receiving set 100.

Remote control 42 receives a desired operation from the user to transmit an operation signal according to the user's operation to broadcast receiving set 100 by infrared radiation. It is noted that an output from remote control 42 is not limited to an infrared operation signal and may be a radio operation signal. Furthermore, in place of remote control 42 or a remote control reception unit 26, or in addition to remote control 42 or remote control reception unit 26, the main unit of broadcast receiving set 100 may be provided with an operation receiving unit receiving an operation from the user to output an operation signal to control unit 10.

Broadcast receiving set 100 includes a control unit 10, a tuner 16, a demodulation unit 18, a decoder 22, a remote control reception unit 26, and a monitor 400.

Control unit 10 includes a CPU (Central Processing Unit) 10A executing a program and a memory 10B storing the executed program, data in the course of execution of the program, and data resulting from execution of the program.

Tuner 16 extracts a broadcast signal corresponding to a channel selected in response to an instruction from control unit 10 from the received broadcast signals. Then, tuner 16 outputs the extracted broadcast signal to demodulation unit 18.

Demodulation unit 18 receives the broadcast signal from tuner 16, demodulates the broadcast signal to MPEG-2TS (Moving Picture Experts Group phase 2 Transport Stream) signal, which is digitally-coded video and audio signals, and outputs the MPEG-2TS signal to decoder 22.

Here, a digital television broadcast signal is coded in Read-Solomon Code and Convolutional Code for transmission. Therefore, demodulation unit 18 can correct an error in the aforementioned demodulation process. In the course of the error correction processing, demodulation unit 18 calculates a received data error rate of the received broadcast signal and outputs the received data error rate to control unit 10. At this point, demodulation unit 18 performs error correction for each prescribed number of data included in the received broadcast signal, so that the received data error rate can be calculated within one frame (one-thirtieth second) from the start of reception. Control unit 10 can determine a signal level of a broadcast signal by a received data error rate.

It is noted that the digital television broadcasting includes ISDB-T (Integrated Services Digital Broadcasting for Terrestrial) system in Japan and, in addition, ATSC (Advanced Television Systems Committee) system In the United States and DVB-T (Digital Video Broadcasting for Terrestrial) system In Europe. In any system, a broadcast signal is coded for transmission to allow an error correction, during which course a received data error rate can be calculated. Accordingly, demodulation unit 18 in the first embodiment of the present invention may use any of the aforementioned systems.

Decoder 22 decodes the MPEG-2TS signal received from demodulation unit 18 to a video signal and an audio signal. Then, decoder 22 outputs the decoded video signal and audio signal to monitor 400.

Monitor 400 converts the video signal and the audio signal from decoder 22 to video and audio, respectively, so that the user can enjoy the converted video and audio.

Remote control reception unit 26 receives an operation signal from remote control 42 and outputs the received operation signal to control unit 10.

Control unit 10 controls tuner 16, demodulation unit 18, and decoder 22 according to the operation signal received from remote control reception unit 26.

Referring to FIG. 2, remote control 42 includes, as operation receiving portions receiving an operation from the user, a power button 421, a channel-selection button 422, a volume UP button 423, a volume DOWN button 424, a history button 425, a channel UP button 426, and a channel DOWN button 427.

Power button 421 is an operation receiving portion for receiving an operation to switch on and off the power of broadcast receiving set 100.

Channel selection button 422 from “1” to “12” is an operation receiving portion for receiving a channel-selection operation for the user to select a desired channel.

Volume UP button 423 and volume DOWN button 424 are operation receiving portions for receiving operations to increase and decrease the volume output from monitor 400, respectively.

History button 425 is an operation receiving portion for receiving a historical channel-selection operation to select a channel based on the order of channels specified by a history list as described later.

Channel UP button 426 and channel DOWN button 427 are operation receiving portions for receiving a channel-selection operation to select a channel by switching channels one by one in the directions of decreasing order and increasing order, respectively.

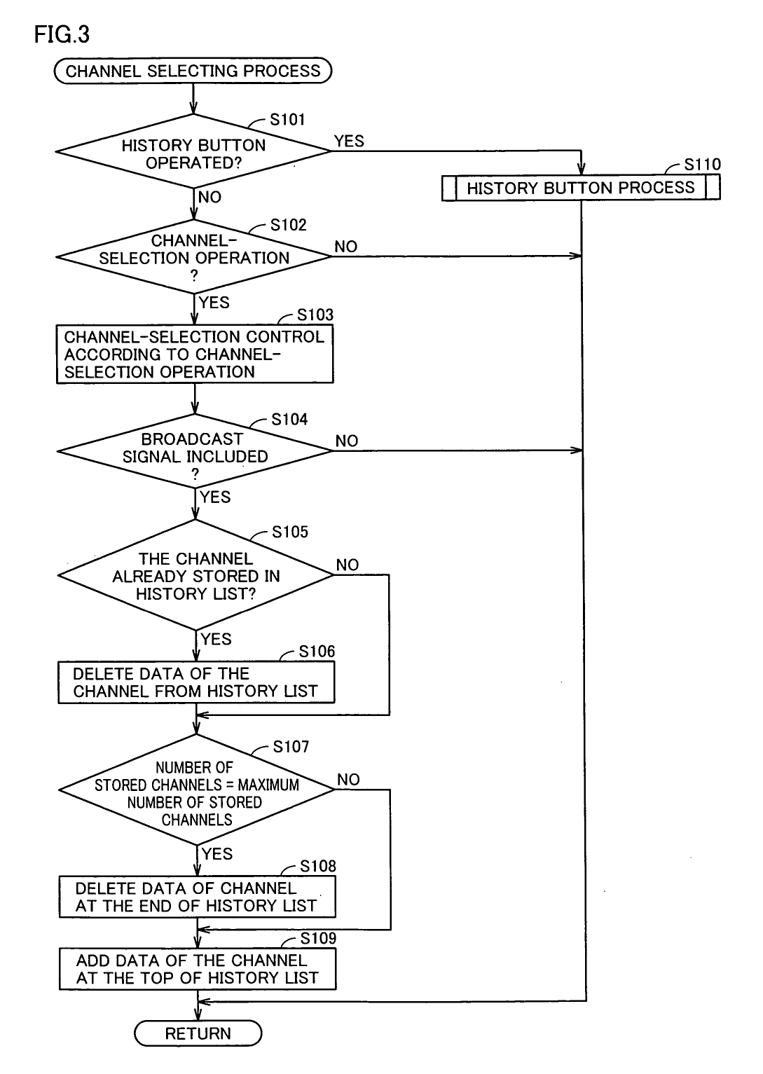

Referring to FIG. 3, first, at step S101, CPU 10A determines whether or not a historical channel-selection operation signal is received from remote control reception unit 26, which indicates that a historical channel-selection operation is performed by operating history button 425 of remote control 42. In other words, it is determined whether or not the user performs a channel-selection operation. If it is determined that a historical channel-selection operation signal is received (if YES at step S101), at step S110, CPU 10A performs a history button process as described later.

On the other hand, if it is determined that a historical channel-selection operation signal is not received (if NO at step S101), at step S102, CPU 10A determines whether or not a channel-selection operation signal is received from remote control reception unit 26, which indicates that a channel-selection operation is performed by operating channel-selection button 422, channel UP button 426 or channel DOWN button 427 of remote control 42. If it is determined that a channel-selection operation signal is not received (if NO at step S102), CPU 10A returns the process to be performed to the caller process of this channel selecting process.

On the other hand, if it is determined that a channel-selection operation signal is received (if YES at step S102), at step S103, CPU 10A performs channel-selection control to control tuner 16 such that a channel corresponding to the channel-selection operation signal is selected.

Then, at step S104, CPU 10A determines whether or not the channel selected by tuner 16 includes a broadcast signal, based on the signal from demodulation unit 18. In other words, it is determined whether or not the signal output from tuner 16 to demodulation unit 18 includes MPEG-2TS signal. If it is determined that a broadcast signal is not included (if NO at step S104), CPU 10A returns the process to be performed to the caller process of this channel selecting process.

On the other hand, if it is determined that a broadcast signal is included (if YES at step S104), at step S105, CPU 10A determines whether or not channel information indicating the channel selected through the channel-selection control at step S103 has already been stored in a history list.

TABLE 1
10ch
4ch
8ch
6ch

Table 1 shows an exemplary history list. Referring to Table 1, the history list is stored in memory 10B. Here, channel information indicating Channel 10, Channel 4, Channel 8, and Channel 6 is stored in the history list. Then, this history list shows that the order in which the channel information is stored in the history list is: Channel 10, Channel 4, Channel 8, Channel 6, in order from the last one. In this manner, the channel information is stored such that the order in which each channel information is stored in the history list can be specified.

It is noted that here, the history list is shown in the form of a table, for the sake of convenience. However, the channel information may be stored in continuous memory regions in memory 10B. Alternatively, the channel information may be stored in the form of a list structure, in which pointer information that can specify a storage region of memory 10B storing the preceding or following channel information is stored in association with each channel information.

For example, when Channel 8 is selected through the channel-selection control at step S103, it is determined that the channel information indicating Channel 8 has already been stored in the history list in Table 1. On the other hand, when Channel 2 is selected through the channel-selection control at step S103, it is determined that the channel information indicating Channel 2 has not been stored in the history list in Table 1.

If it is determined that channel information has already been stored in the history list (if YES at step S105), at step S106, CPU 10A deletes the channel information that has already been stored from the history list.

On the other hand, if it is determined that channel information has not been stored in the history list (if NO at step S105), or after step S106, at step S107, CPU 10A determines whether or not the number of the channel information that has already been stored, that is, the number of stored channels, reaches the maximum number of channel information that can be stored in a storage region to store channel information in memory 10B, that is, the maximum number of stored channels.

If it is determined that the number of stored channels reaches the maximum number of stored channels (if YES at step S107), at step S108, CPU 10A deletes the channel information that was first stored in the history list.

On the other hand, if it is determined that the number of stored channels does not reach the maximum number of stored channels (if NO at step S107), or after step S108, at step S109, CPU 10A stores the channel information as the channel information that is stored last in the history list (the top (the uppermost field) of Table 1). Thereafter, CPU 10A returns the process to be performed to the caller process of this channel selecting process.

For example, when Channel 8 is selected through the channel-selection control at step S103, it is determined that Channel 8 has already been stored in the history list of Table 1 at step S105. Therefore, at step S106, the channel information indicating Channel 8 (the third field from the top in Table 1) is deleted, and then the number of stored channels becomes three. In this embodiment, since the maximum number of stored channels is four, at step S107, it is determined that the number of stored channels does not reach the maximum number of stored channels, and at step S109, channel information indicating Channel 8 is added on the top of the history list.

TABLE 2
8ch
10ch
4ch
6ch

Table 2 shows the history list after Channel 8 is selected through the channel-selection control from the history list of Table 1. Referring to Table 2, as a result that Channel 8 is selected through channel-selection control, the history list of Table 1 indicating the order of Channel 10, Channel 4, Channel 8, Channel 6 is changed to the history list indicating the order of Channel 8, Channel 10, Channel 4, Channel 6.

Now, a history button process that is performed at step S110 in FIG. 3 will be described.

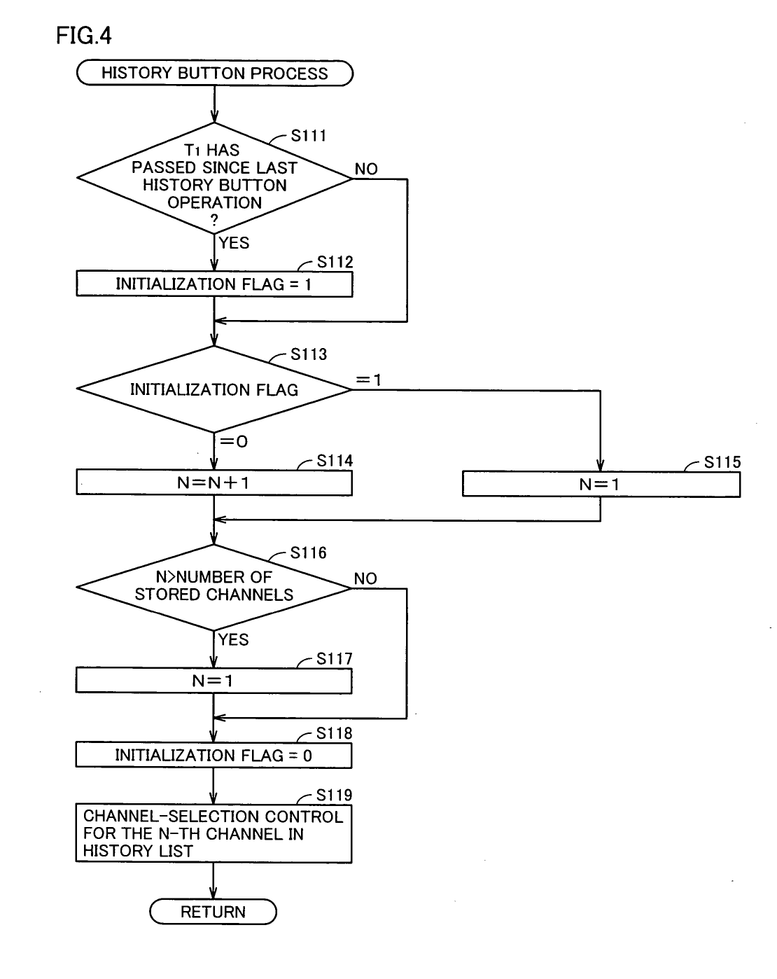

Referring to FIG. 4, first, at step S111, CPU 10A determines whether or not a time T₁ has passed since a historical channel-selection operation signal was received last time, indicating that a historical channel-selection operation was performed by operating history button 425. In other words, it is determined whether or not time T₁ has passed since history button 425 was operated last time. Time T₁ is a period of time on the order of seconds shorter than one minute, for example, from five seconds to ten seconds.

If it is determined that time T₁ has passed since the last operation (if YES at step S111), at step S112, CPU 10A sets the value of an initialization flag to 1. The initialization flag indicates that time T₁ has passed since the historical channel-selection operation signal was received last time. When time T₁ has passed, the flag is set to a value of 1, and when time T₁ has not passed, it is set to a value of 0.

On the other hand, if it is determined that time T₁ has not passed since the last operation (if NO at step S111), or after step S112, at step S113, CPU 10A determines whether the value of the initialization flag is 0 or 1.

If it is determined that the value of the initialization flag is 0 (0 at step S113), at step S114, CPU 10A adds 1 to the value of N. N is a variable indicating the channel of the N-th channel information in the history list is presently selected. On the other hand, if it is determined that the value of the initialization flag is 1(1 at step S113), at step S115, CPU 10A sets the value of N to 1. At step S114 or after step S115, CPU 10A advances the process to be performed to step S116.

At step S116, CPU 10A determines whether or not the value of N is greater than the number of stored channels as described at step S107 in FIG. 3. If it is determined that the value of N is greater than the number of stored channels (if YES at step S116), at step S117, CPU 10A sets the value of N to 1.

On the other hand, if it is determined that the value of N is not greater than the number of stored channels (if NO at step S116), or after step S117, at step S118, CPU 10A sets the value of the initialization flag to 0.

Then, at step S119, CPU 10A performs channel-selection control on tuner 16 such that the channel indicated by the N-th channel information in the history list is selected. Thereafter, CPU 10A returns the process to be performed to the channel selecting process that calls this history button process.

As described above, according to broadcast receiving set 100 in the first embodiment, a channel-selection operation is received to select the user's desired channel from a plurality of channels. Then, channel-selection control is performed to select the desired channel according to the received channel-selection operation. Then, the desired channel is stored in the history list that can specify the order in which channel-selection control for desired channels is performed.

Furthermore, a historical channel-selection operation is received to select a channel based on the stored order. Then, historical channel-selection control is performed according to the received historical channel-selection operation to select a channel indicated by the channel information stored at the ordinal position that temporally immediately precedes the ordinal position in which the channel information indicating the channel last selected is stored.

Accordingly, every time a historical channel-selection operation is received, a channel at an ordinal position that temporally precedes is selected, according to the order in which channels are selected through the channel-selection control. As a result, the channel that was selected in the past can easily be selected, thereby reducing the burden of selecting a channel on the user.

In addition, according to broadcast receiving set 100, when a historical channel-selection operation is received after time T₁ has passed since historical channel-selection control was performed, the channel indicated by the channel information on the top of the history list, which is stored at the last position in terms of time, is selected.

Therefore, when the user does not switch and leaves the channel selected by the historical channel-selection operation as it is for time T₁ or longer, a historical channel-selection operation can be performed again in order, starting from the channel indicated by the channel information on the top of the history list, which is stored at the last position in terms of time.

Furthermore, according to broadcast receiving set 100, when the user's desired channel selected through a channel-selection operation is the already-stored channel indicated by the channel information that has already been stored in the history list, the desired channel is newly stored on the top of the history list, and in addition, the channel information indicating the already-stored channel is deleted.

Therefore, when channel-selection control is performed, even a channel that has already been stored in the history list is newly stored on the top of the history list, so that the desired channels can be stored in the order frequently selected. As a result, the channels selected in the past can be selected in the order frequently selected, thereby further reducing the burden of selecting a channel on the user.

### Second Embodiment

A second embodiment of the present invention will now be described. The second embodiment is a modification to the channel selecting process of the first embodiment. Therefore, the modified channel selecting process will be described.

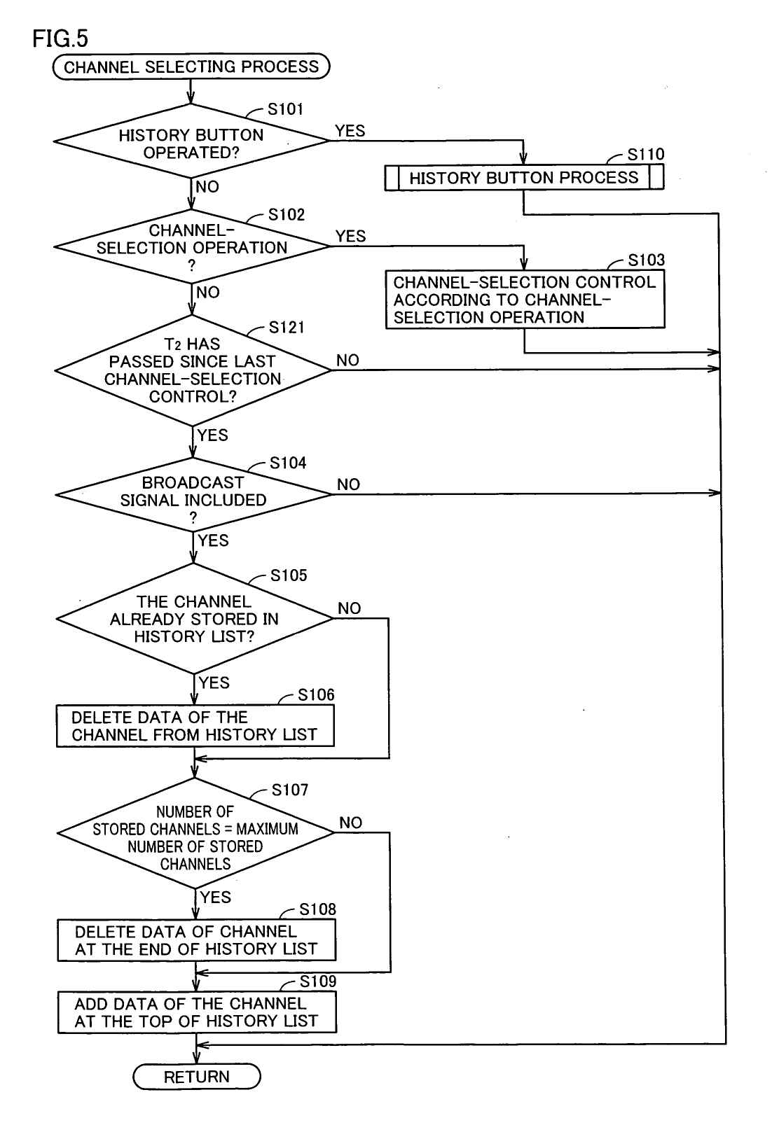

Referring to FIG. 5, the process and the flow of the process at step S101, step S110, step S102, and step S103 are similar to the channel selecting process in the first embodiment as illustrated in FIG. 3 and therefore the description will not be repeated.

If it is determined that a channel-selection operation signal is not received (if NO) at step S102, at step S121, CPU 10A determines whether or not time T₂ has passed since a channel-selection operation signal was received last time. In other words, it is determined whether or not time T₂ has passed since a channel-selection operation was performed by the user operating channel-selection button 422, channel UP button 426, or channel DOWN button 427. Time T₂ is a time on the order of minutes that allows a determination as to whether or not the user is interested in the channel, for example, from about five to ten minutes.

If it is determined that time T₂ has not passed since a channel-selection operation was performed last time (if NO at step S121), CPU 10A returns the process to be performed to the caller process of this channel selecting process. On the other hand, if it is determined that time T₂ has passed since a channel-selection operation was performed last time (if YES at step S121), CPU 10A advances the process to be performed to step S104.

It is noted that at step S121 it may be determined whether or not time T₂ has passed since a channel-selection operation signal or a historical channel-selection operation signal was received, in addition to a determination as to whether or not time T₂ has passed since a channel-selection operation signal was received last time. In other words, it may be determined whether or not time T₂ has passed since the user operated channel-selection button 422, channel UP button 426, channel DOWN button 427, or history button 425 last time.

The process and the flow of the process from step S104 to step S109 are similar to the channel selecting process of the first embodiment as illustrated in FIG. 3 and therefore the description will not be repeated.

It is noted that if a channel-selection operation is performed to select the same channel as the last one, the time from the last channel-selection operation may not be reset and may be continuously counted. In this way, if the same channel as the last one is selected, it is determined that the user does not intend to switch to another channel, that is, the user is interested in the same channel, and the elapsed time since the same channel was selected can be included in the elapsed time since channel-selection control was performed last time. Therefore, even if the elapsed time until the same channel as the last one is selected does not reach time T₂, if the sum of the elapsed time since the same channel was selected and the elapsed time until the same channel as the last one is selected reaches time T₂, that channel is added to the history list.

As described above, according to broadcast receiving set 100 of the second embodiment, on the condition that channel-selection control is not performed when time T₂ has passed since channel-selection control was performed, the user's desired channel is added to the history list.

Therefore, a desired channel that is not switched during time T₂ can be stored in the history list. As a result, only an interested channel that has not been switched and left by the user for time T₂ or longer can be stored.

### Third Embodiment

A third embodiment of the present invention will now be described. The third embodiment relates to a broadcast receiver device 1 having a configuration of broadcast receiving set 100 according to the first embodiment, excluding monitor 400.

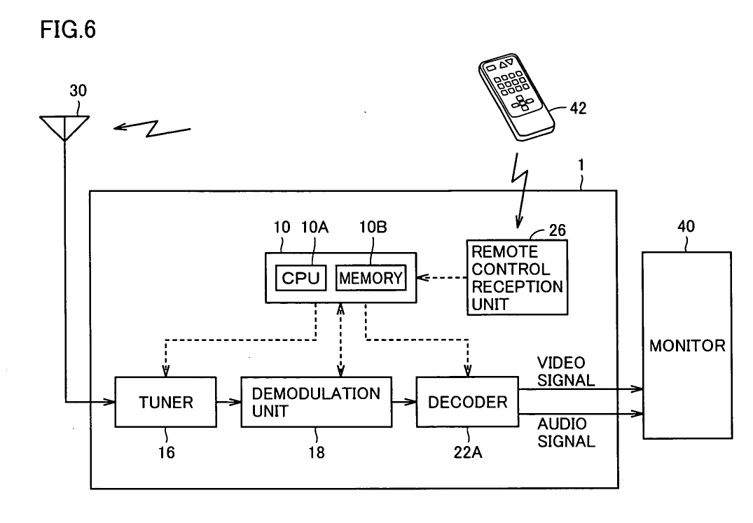

Referring to FIG. 6, broadcast receiver device 1 in accordance with the third embodiment has a configuration of broadcast receiving set 100 according to the first embodiment, excluding monitor 400. More specifically, broadcast receiver device 1 includes control unit 10, tuner 16, demodulation unit 18, a decoder 22A, and remote control reception unit 26.

Decoder 22A decodes MPEG-2TS signal received from demodulation unit 18 to a video signal and an audio signal. Then, decoder 22A outputs the decoded video signal and audio signal to an external monitor 40.

Monitor 40 converts the video signal and the audio signal output from broadcast receiver device 1 to video and audio, respectively, so that the user can enjoy the converted video and audio.

As described above, broadcast receiver device 1 in the third embodiment can bring about the similar effect to broadcast receiving set 100 as described in the first embodiment.

It is noted that in each of the process described above with reference to FIG. 3, FIG. 4, and FIG. 5, the order in which the steps are arranged may be changed as long as inconvenience is not caused at the following step.

In addition, the present invention can be understood as a broadcast recording device recording the received broadcast or a broadcast receiving/recording set outputting or recording the received broadcast, including broadcast receiver device 1 in the third embodiment as described above.

Furthermore, in the first to third embodiments described above, broadcast receiving set 100 and broadcast receiver device 1 have been described, respectively. However, the present invention can be understood as a channel switching method or a channel switching program product to allow broadcast receiving set 100 or broadcast receiver device 1 to perform the process illustrated in FIG. 3 or FIG. 5, and FIG. 4.

It is noted that the channel switching program product is a recording medium such as CD-ROM or DVD having such a program recorded thereon that allows broadcast receiving set 100 or broadcast receiver device 1 to perform the process illustrated in FIG. 3 or FIG. 5, and FIG. 4. The recording medium is manufactured and sold to be installed in broadcast receiving set 100 or broadcast receiver device 1 so that the process illustrated in FIG. 3 or FIG. 5, and FIG. 4 is performed.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A broadcast receiving set comprising:
a channel-selection button receiving a channel-selection operation to select a channel desired by a user from a plurality of channels;
channel-selection control means for performing channel-selection control to select said desired channel according to said channel-selection operation received by said channel-selection button;
history list storing means for storing channel information that can specify said desired channel in a history list that can specify an order in which said channel-selection control for said desired channel is performed by said channel-selection control means, on the condition that said channel-selection control for a different channel is not performed by said channel-selection control means when a prescribed time has passed after said channel-selection control was performed by said channel-selection control means, wherein when said desired channel selected through said channel-selection control by said channel-selection control means is an already-stored channel that has already been stored, said history list storing means newly stores the channel information that can specify said desired channel at a last position in terms of time in said history list and also deletes the channel information of said already-stored channel from said history list;
a history button receiving a historical channel-selection operation to select a channel based on the order specified by said history list stored in said history list storing means;
historical channel-selection control means for performing historical channel-selection control according to said historical channel-selection operation received by said history button, to select a channel specified by the channel information stored in said history list storing means at an ordinal position temporally immediately preceding an ordinal position in which channel information specifying a channel selected last time is stored in said history list storing means, wherein when said historical channel-selection operation is received by said history button after a predetermined time has passed since said historical channel-selection control was performed, said historical channel-selection control means performs said historical channel-selection control to select a channel at a last position in terms of time; and
output means for outputting a broadcast on the channel selected by said channel-selection control means or said historical channel-selection control means.

2. A broadcast receiver device comprising:
channel-selection operation reception means for receiving a channel-selection operation to select a desired channel from a plurality of channels;
channel-selection control means for performing channel-selection control to select said desired channel according to said channel-selection operation received by said channel-selection operation reception means;
order storing means for storing said desired channel such that an order in which said channel-selection control for said desired channel is performed by said channel channel-selection control means can be specified;
particular channel-selection operation reception means for receiving a particular channel-selection operation to select a channel based on the order stored in said order storing means; and
particular channel-selection control means for performing particular channel-selection control according to said particular channel-selection operation received by said particular channel-selection operation reception means, to select the channel stored in said order storing means at an ordinal position temporally preceding an ordinal position in which a channel selected last time is stored in said order storing means.

3. The broadcast receiver device according to claim 2, wherein said order storing means stores said desired channel as channel specifying information that can specify said desired channel.

4. The broadcast receiver device according to claim 2, wherein said order storing means stores said desired channel on the condition that when said channel-selection control for a different channel is not performed by said channel-selection control means when a prescribed time has passed since said channel-selection control was performed by said channel-selection control means.

5. The broadcast receiver device according to claim 2, wherein said particular channel-selection control means performs said particular channel-selection control to select a channel at a last position in terms of time, when said particular channel-selection operation was received by said particular channel-selection operation reception means after a predetermined time has passed since said particular channel-selection control was performed by said particular channel-selection control means.

6. The broadcast receiver device according to claim 2, wherein said order storing means stores each of a channel selected through said channel-selection control by said channel-selection control means and a channel selected through said particular channel-selection control by said particular channel-selection control means.

7. The broadcast receiver device according to claim 2, wherein when said desired channel selected through said channel-selection control by said channel-selection control means is an already-stored channel that has already been stored, said order storing means newly stores said desired channel at a last position in terms of time and also deletes said already-stored channel.

8. A broadcast receiving set comprising:
channel-selection operation reception means for receiving a channel-selection operation to select a desired channel from a plurality of channels;
channel-selection control means for performing channel-selection control to select said desired channel according to said channel-selection operation received by said channel-selection operation reception means;
order storing means for storing said desired channel such that an order in which said channel-selection control for said desired channel is performed by said channel-selection control means can be specified;
particular channel-selection operation reception means for receiving a particular channel-selection operation to select a channel based on the order stored in said order storing means;
particular channel-selection control means for performing particular channel-selection control according to said particular channel-selection operation received by said particular channel-selection operation reception means, to select a channel stored in said order storing means at an ordinal position temporally preceding an ordinal position in which a channel selected last time is stored in said order storing means; and
output means for outputting a broadcast on the channel selected by said channel-selection control means or said particular channel-selection control means.

9. A channel selecting method of selecting a channel by a broadcast receiver device comprising the steps of:
receiving a channel-selection operation to select a desired channel from a plurality of channels;
performing channel-selection control to select said desired channel according to the received channel-selection operation;
storing said desired channel such that an order in which said channel-selection control for said desired channel is preformed can be specified;
receiving a particular channel-selection operation to select a channel based on the stored order; and
performing particular channel-selection control according to received said particular channel-selection operation to select a channel stored at an ordinal position temporally preceding an ordinal position in which a channel selected last time is stored.

10. A channel selecting program product causing a broadcast receiver device to perform the steps of:
receiving a channel-selection operation to select a desired channel from a plurality of channels;
performing channel-selection control to select said desired channel according to the received channel-selection operation;
storing said desired channel such that an order in which said channel-selection control for said desired channel is preformed can be specified;
receiving a particular channel-selection operation to select a channel based on the stored order; and
performing particular channel-selection control according to received said particular channel-selection operation to select a channel stored at an ordinal position temporally preceding an ordinal position in which a channel selected last time is stored.
